(19) United States
(12) Patent Application Publication
(10) Pub. No.: US 2011/0149793 A1
(43) Pub. Date: Jun. 23, 2011

(54) TRAFFIC CAPTURE APPARATUS AND TRAFFIC ANALYSIS APPARATUS, SYSTEM AND METHOD

(75) Inventors: Myung-Sup KIM, Chungcheongnam-do (KR); Tae-Sang CHOI, Daejeon (KR); Sun-Hee YANG, Daejeon (KR)

(73) Assignees: Electronics and Telecommunications Research Institute, Daejeon (KR); Korea University Research and Business Foundation, Seoul (KR)

(21) Appl. No.: 12/955,812

(22) Filed: Nov. 29, 2010

(30) Foreign Application Priority Data
Dec. 18, 2009 (KR) 10-2009-0127293

(51) Int. Cl. H04L 12/26

(52) U.S. Cl. 370/253

(57) ABSTRACT

Provided are a traffic capture apparatus and a traffic analysis apparatus, system and method. The traffic analysis system generates a two-way flow based on one or more packets captured through a network and associates the two-way flow with a corresponding application program by using information about transmission directions and payload sizes of payload packets, each of which has a payload in the two-way flow.

### CROSS-REFERENCE TO RELATED APPLICATION

This application claims the benefit under 35 U.S.C. §119(a) of a Korean Patent Application No. 10-2009-0127293, filed on Dec. 18, 2009, the entire disclosure of which is incorporated herein by reference for all purposes.

### BACKGROUND

1. Field

The following description relates to network management and service technology, and more particularly, traffic management technology.

2. Description of the Related Art

Various technologies are available to classify network traffic according to application program. Of the technologies, a signature-based classification method is to classify traffic by using a signature which is unique for each application program.

One example of the signature-based classification method is a payload string signature-based classification method. In this method, it is determined whether a unique string signature of an application program exists in payloads of packets that form traffic, and the traffic is classified based on the determination result. Accordingly, this method can increase the accuracy of traffic classification.

However, the payload string signature-based classification method involves examining the content of payloads. Thus, the privacy of an individual can be invaded. That is, since personal information can be included in payloads of packets, examining the content of the payloads may cause legal problems with respect to the invading of personal privacy.

In addition, the payload string signature-based classification method requires fast processing performance during traffic classification. This is because payloads of all packets need to be examined using this method. Also, real-time traffic classification is essential today. Accordingly, the payload string signature-based classification method needs high-performance hardware to simultaneously process a large amount of network traffic. In this regard, the payload string signature-based classification method is not suitable to high-speed networks of Gbps or higher.

### SUMMARY

The following description relates to network traffic classification technology which is applicable to high-speed networks and does not invade the privacy of personal information.

In one general aspect, there is provided a traffic capture apparatus including: a packet capture unit capturing one or more packets passing through a network; a flow generation unit generating a two-way flow based on the captured packets; and a payload statistical information generation unit generating payload statistical information based on payload packets in the generated two-way flow, wherein each of the payload packets has a payload, and the payload statistical information contains information about transmission directions and payload sizes of the payload packets.

In another aspect, there is provided a traffic analysis apparatus including: a payload statistical signature storage unit storing payload statistical signatures which have different information about transmission directions and payload sizes of payload packets for each application program; and a traffic classification unit associating a two-way flow received from a traffic capture apparatus, which captures traffic, with a corresponding application program by using the payload statistical signature.

In another aspect, there is provided a traffic analysis system including: a traffic capture apparatus capturing one or more packets through a network, generating a two-way flow based on the captured packets, and generating payload statistical information based on payload packets in the two-way flow; and a traffic analysis apparatus receiving the two-way flow, which has the payload statistical information, from the traffic capture apparatus and associating the two-way flow with a corresponding application program by using payload statistical signatures which have different information about transmission directions and payload sizes of payload packets for each application program, wherein each of the payload packets has a payload, and the payload statistical information contains information about transmission directions and payload sizes of the payload packets.

In another aspect, there is provided a traffic analysis method including: establishing a list of payload statistical signatures, each having different information about transmission directions and payload sizes of payload packets for a corresponding application program; comparing payload statistical information of a two-way flow captured through a network with a corresponding payload statistical signature in the list of payload statistical signatures; and associating the two-way flow with a corresponding application program based on the comparison result, wherein each of the payload packets has a payload, and the payload statistical information contains information about transmission directions and payload sizes of payload packets.

Other features and aspects will be apparent from the following detailed description, the drawings, and the claims.

### BRIEF DESCRIPTION OF THE DRAWINGS

FIG. 1 is a block diagram of an example traffic analysis system;

FIG. 2 is a block diagram of an example traffic capture apparatus;

FIG. 3 is a block diagram of an example traffic analysis apparatus;

FIG. 4 is a diagram illustrating the structure of an example flow record which includes payload statistical information; and

FIG. 5 is a flowchart illustrating an example traffic analysis method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The invention is described more fully hereinafter with reference to the accompanying drawings, in which exemplary embodiments of the invention are shown. Descriptions of well-known functions and constructions are omitted to increase clarity and conciseness. Also, the terms used in the following description are terms defined taking into consideration the functions obtained in accordance with the present invention, and may be changed in accordance with the option of a user or operator or a usual practice. Therefore, the definitions of these terms should be determined based on the entire content of this specification.

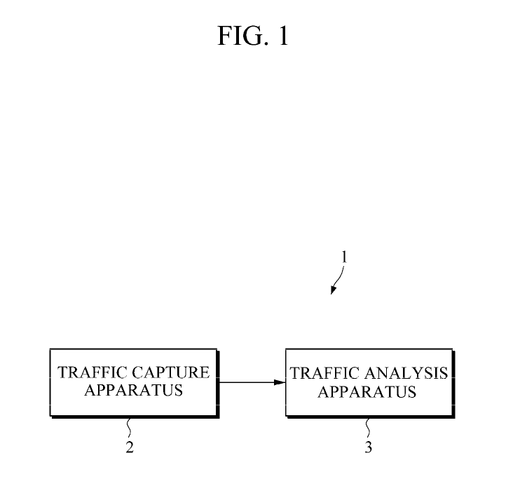

FIG. 1 is a block diagram of an example traffic analysis system 1. Referring to FIG. 1, the example traffic analysis system 1 includes a traffic capture apparatus 2 and a traffic analysis apparatus 3.

The traffic capture apparatus 2 captures packets passing through a network and generates a two-way flow based on the captured packets. Then, the traffic capture apparatus 2 generates payload statistical information based on payload packets in the two-way flow. Each of the payload packets has a payload, and the payload statistical information contains information about the transmission direction and payload size of each of the payload packets.

A two-way flow is a combination of two one-way flows used for a communication connection between two hosts and has information about transmission directions and payload sizes. A payload packet is a packet that includes a payload having application layer information. Control packets are not payload packets. For example, control packets for a transmission control protocol (TCP), such as a synchronization (SYN) packet, a finish (FIN) packet and a reset (RST) packet, are not payload packets.

Payload statistical information is a combination of a payload packet vector V, which indicates the transmission directions and payload sizes of payload packets, and the number n of payload packets which form the payload packet vector V. The payload statistical information may be expressed for n packets, which occur in chronological order, in a two-way flow.

Each transmission direction in the payload packet vector V may be represented by a plus sign (+) or a minus sign (−). The plus sign (+) indicates that the transmission direction of a payload packet is from a client to a server. Conversely, the minus sign (−) indicates that the transmission direction of the payload packet is from the server to the client.

A host may be designated as a client or a server, depending on the type of protocol. For example, if the TCP is used to exchange packets between hosts, a host that receives an SYN packet is designated as a server. In another example, if a user datagram protocol (UDP) is used, a host that receives a first packet is designated as a server.

Each payload size in the payload packet vector V has a data size of a payload having the application layer information. That is, each payload size in the payload packet vector V has a data size of only an application layer, excluding a transport layer protocol header, a network layer protocol header, etc. of a packet. Each payload size in the payload packet vector V may be expressed in bytes.

The transmission direction and payload size of a payload packet are represented together by a number having a plus sign (+) or a minus sign (−). For example, ‘+20’ represents a packet having a payload size of 20 bytes and heading for a server.

The traffic analysis apparatus 3 receives a two-way flow having payload statistical information from the traffic capture apparatus 2. Then, the traffic analysis apparatus 3 associates the two-way flow with a corresponding application program by using a payload statistical signature. The payload statistical signature includes different information about transmission directions and payload sizes of payload packets for each application program.

A statistical signature is unique for an application program, and can be used to distinguish the application program from other application programs, and is identified using statistical features that can be obtained from headers of packets or the capture information of the packets. In the present invention, a payload statistical signature using the transmission directions and payload sizes of payload packets is defined in respect of a two-way flow. One payload statistical signature is matched with one application program. An application program can have a plurality of payload statistical signatures.

A payload statistical signature is a combination of a transport layer protocol p, a payload packet vector V indicating the transmission directions and payload sizes of payload packets, the number n of payload packets that form the payload packet vector V, a distance threshold d, and an application program name A.

Each transmission direction in the payload packet vector V may be represented by a plus sign (+) or a minus sign (−). The plus sign (+) indicates that the transmission direction of a payload packet is from a client to a server. Conversely, the minus sign (−) indicates that the transmission direction of the payload packet is from the server to the client.

Each payload size in the payload packet vector V has a data size of a payload having the application layer information. That is, each payload size in the payload packet vector V has a data size of only an application layer, excluding a transport layer protocol header, a network layer protocol header, etc. of a payload packet. Each payload size in the payload packet vector V may be expressed in bytes.

The transmission direction and payload size of a payload packet are represented together by a number having a plus sign (+) or a minus sign (−). For example, ‘+20’ represents a packet having a payload size of 20 bytes and heading from a client to a server, and ‘−100’ indicates a packet having a payload size of 100 bytes and heading from the server to the client.

As described above, the example traffic analysis system 1 classifies traffic by using the transmission directions and payload sizes of payload packets, instead of examining the content of the payload packets. Consequently, the example traffic analysis system 1 does not invade the privacy of personal information and is applicable to high-speed networks.

The above-described operations of the traffic capture apparatus 2 and the traffic analysis apparatus 3 are performed in real time. That is, the operations of capturing all packets through a network, generating a two-way flow, extracting payload statistical information from the two-way flow, and associating the two-way flow with a corresponding application program by comparing the payload statistical information with a payload statistical signature are performed in real time.

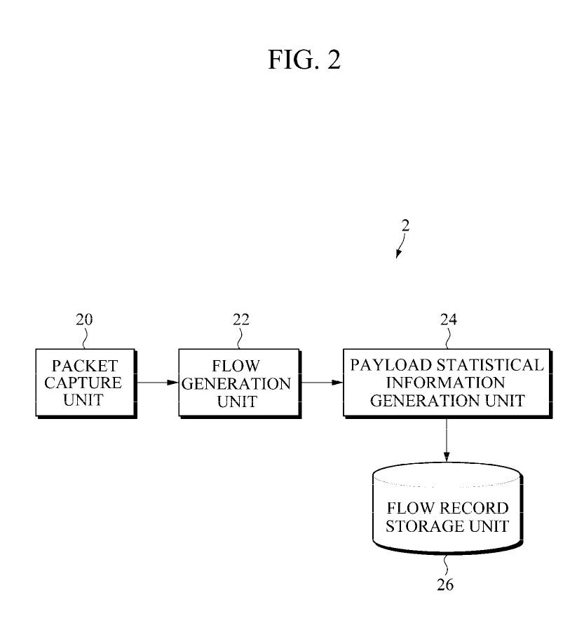

FIG. 2 is a block diagram of the traffic capture apparatus 2 shown in FIG. 1. Referring to FIG. 2, the traffic capture apparatus 2 includes a packet capture unit 20, a flow generation unit 22, and a payload statistical information generation unit 24.

The packet capture unit 20 captures packets through a network. Here, the packet capture unit 20 may capture all packets using a router or a switch in an Internet network.

In an example, the packet capture unit 20 may, in real time, capture all packets by tapping a high-speed physical line or using a port mirroring function of a switch or a router in an Internet network and provide the capture packets to the flow generation unit 22. If multiple Internet lines are connected to a network, the packet capture unit 20 has to perform an additional operation of capturing packets at multiple locations and merging the captured packets at one location.

The flow generation unit 22 generates a two-way flow from one or more packets captured by the packet capture unit 20. Here, the flow generation unit 22 includes one or more packets in a group by using 5-tuple information and generates a two-way flow based on the group of packets. The 5-tuple information includes Internet protocol (IP) addresses and port numbers of both ends of a communication and a transport layer protocol used for the communication.

A flow is a group of packets which are the same in at least one of source IP, destination IP, source port, destination port, and transport layer protocol. A one-way flow is a group of all packets transmitted in one direction of a communication connection. For one communication connection, two one-way flows are created.

In the present invention, a group of all packets used for one communication connection between two hosts is defined as a two-way flow, and a flow record is created based on this definition. This is because a payload statistical signature requires the transmission directions and payload sizes of payload packets for one communication connection. A two-way flow record is a combination of the records of two one-way flows. A two-way flow record basically stores IP addresses and port numbers of two hosts and a transport layer protocol. Additionally, the two-way flow may store various kinds of information, such as the numbers of packets and bytes in each of two directions.

The payload statistical information generation unit 24 generates payload statistical information based on payload packets of a two-way flow. Each of the payload packets has a payload, and the payload statistical information contains information about the transmission direction and payload size of each of the payload packets. The payload statistical information generation unit 24 may generate the payload statistical information of each flow based on a maximum of n payload packets in each flow. The n packets may be selected in the order they are captured. The value of n may vary according to network conditions. For example, the value of n may be between 4 and 6.

The traffic capture apparatus 2 may further include a flow record storage unit 26. The flow record storage unit 26 generates and stores a flow record which includes payload statistical information, a flow identifier, and basic flow information. Payload statistical information F included in a flow record may be defined by Equation 1:

F={n,V} (1).

According to Equation 1, elements of the payload statistical information F included in the flow record are n and V, where n is the number of payload packets that form a payload packet vector V, and V is a payload packet vector of n elements {F₀, F₁, F₂, . . . , Fₙ₋₁}. In addition, Fₖ is an integer (k=1, 2, . . . , n−1).

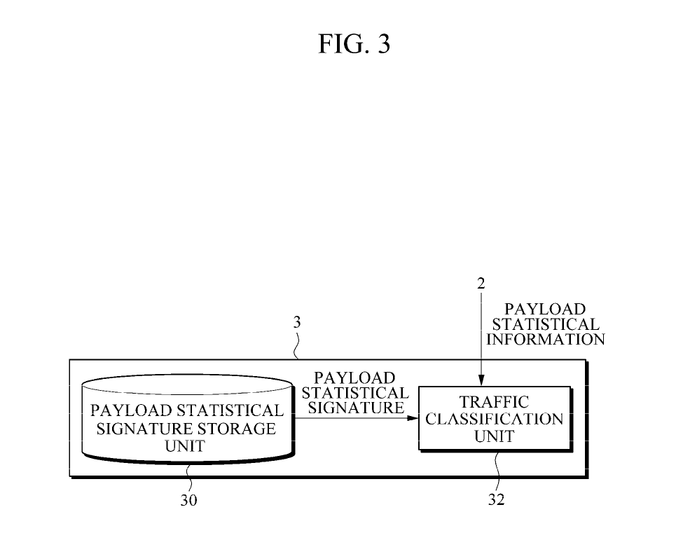

FIG. 3 is a block diagram of the traffic analysis apparatus 3 shown in FIG. 1. Referring to FIG. 3, the traffic analysis apparatus 3 includes a payload statistical signature storage unit 30 and a traffic classification unit 32.

The payload statistical signature storage unit 30 stores a payload statistical signature having different information about transmission directions and payload sizes of payload packets for each application program. A statistical signature of an application program is unique and can be used to distinguish the application program from other application programs, by referring to statistical features that can be obtained from headers of packets or the capture information of the packets. Examples of the statistical features include the distribution of packet sizes, the distribution of packet inter-arrival times, and, in the case of the TCP, the distribution of window sizes. In the present invention, each application program uses a payload statistical signature which is based on its packet size distribution.

Elements of an example payload statistical signature S are shown in Equation 2:

S={p,n,W,d,A} (2).

That is, the payload statistical signature S may consist of a transport layer protocol p, a payload packet vector V indicating the transmission directions and payload sizes of payload packets, the number n of payload packets that form the payload packet vector V, a distance threshold d, and an application program name A. Here, V is a payload packet vector of n elements {S₀, S₁, S₂, . . . , Sₙ₋₁}, and Sₖ is an integer (k=1, 2, . . . , n−1). The transport layer protocol p may be a TCP or an UDP.

The application program name A is the name of an application program having values of p, n, and V. The payload packet vector V consists of n integers indicating the payload sizes and transmission directions of n payload packets. The sign of each integer indicates the transmission direction of a packet, and the absolute value of each integer indicates the payload size of the packet. That is, a positive number indicates a packet heading from a client to a server, and a negative number indicates a packet heading from the server to the client. The payload packet vector V has n-dimensional integers.

The distance threshold d is a value used to classify a flow and is represented by a positive integer. The distance threshold d is used as a basis for determining which application program a flow is associated with by comparing payload statistical information included in a flow record with a payload statistical signature.

The traffic classification unit 32 associates a two-way flow received from the traffic capture apparatus 2 with a corresponding application program by using a payload statistical signature. In the present invention, the traffic classification unit 32 may check all payload statistical signatures for each two-way flow by using a specified condition. When finding a payload statistical signature that satisfies the specified condition, the traffic classification unit 32 may associate a corresponding two-way flow with an application program indicated by the found payload statistical signature.

In an example, the traffic classification unit 32 may classify a two-way flow based on the distance between a payload packet vector included in payload statistical information and a payload packet vector included in a payload statistical signature. Here, if the two-way flow exists within a distance threshold d included in the payload statistical signature, the traffic classification unit 32 associates the two-way flow with an application program indicated by the payload statistical signature.

For example, a payload packet vector in a payload statistical signature may be (+30, −100, −200), and a distance threshold d may be 10. In addition, the number of payload packets included in a captured flow may be three. For direction and size, a first packet may have a value of +31, a second packet may have a value of −98, and a third packet may have a value of −200. Accordingly, a payload packet vector in payload statistical information may be (+31, −98, −200). Here, if the measured distance between the payload packet vector included in the payload statistical information and the payload packet vector included in the payload statistical signature is less than 10, the captured flow is associated with an application program indicated by the payload statistical signature.

According to the present invention, the distance between two vectors may be measured using a city-block distance calculation method. If the city-block distance calculation method is used in the above example, the distance between the payload packet vector included in the payload statistical information and the payload packet vector included in the payload statistical signature is 3 [|{+31−(+30)}|+|{−98−(−100)}|+|{−200−(−200)}|]. Since the distance between the two vectors is less than 10, the captured flow is associated with an application program indicated by the payload statistical signature. The city-block distance calculation method will be described in detail later with reference to FIG. 6.

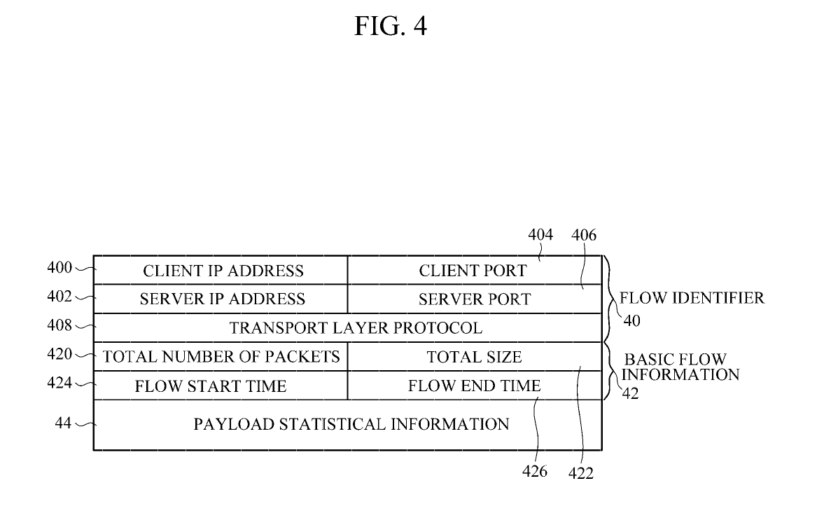

FIG. 4 is a diagram illustrating the structure of an example flow record which includes payload statistical information.

Referring to FIG. 4, the flow record may broadly be divided into three parts. That is, the flow record may consist of a flow identifier 40 which is 5-tuple information used to classify a flow, basic flow information 42, and payload statistical information 44.

The flow identifier 40 includes a client IP address 400, a server IP address 402, a client port 404, a server port 406, and a transport layer protocol 408. The basic flow information 42 includes a total number of packets 420, a total size of packets 422, a flow start time 424, and a flow end time 426. The payload statistical information 44 may contain information about transmission directions of a maximum of n captured payload packets in each flow, in addition to information about payload sizes of the n payload packets. The payload statistical information 44 may be stored in the form of a vector. Since the payload statistical information 44 has been described above with reference to FIGS. 1 and 2, a detailed description thereof will be omitted.

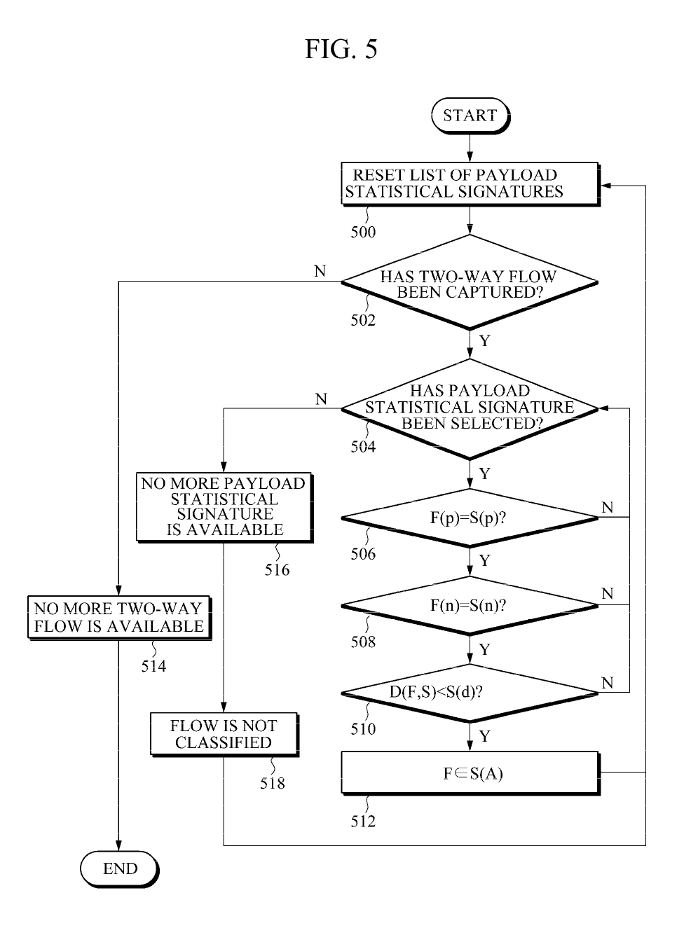

FIG. 5 is a flowchart illustrating an example traffic analysis method. Referring to FIG. 5, the traffic analysis apparatus 3 of FIG. 3 establishes a list of payload statistical signatures and resets the list of payload statistical signatures (operation 500). A payload statistical signature S contains different information about transmission directions and payload sizes of payload packets for each application program. The payload statistical signature S is a combination of a transport layer protocol p, a payload packet vector V indicating the transmission directions and payload sizes of payload packets, the number n of payload packets that form the payload packet vector V, a distance threshold d, and an application program name A.

The traffic analysis apparatus 3 compares payload statistical information F with a corresponding payload statistical signature S in the list of payload statistical signatures (operations 506, 508, and 510). The payload statistical information F includes information about the transmission directions and payload sizes of payload packets, each of which has a payload, in a two-way flow captured through a network. When no captured two-way flow exists (operation 514), the packet analysis process is terminated.

Specifically, the traffic analysis apparatus 3 compares a transport layer protocol F(p) of the payload statistical information F with a transport layer protocol S(p) of the corresponding payload statistical signature S (operation 506).

If the transport layer protocols F(p) and S(p) match each other (F(p)=S(p)), the traffic analysis apparatus 3 compares the number F(n) of payload packets which form a payload packet vector of the payload statistical information F with the number S(n) of payload packets which form a payload packet vector of the corresponding payload statistical signature S (operation 508). If the transport layer protocols F(p) and S(p) do not match each other (F(p)≠S(p)), the traffic analysis apparatus 3 selects another payload statistical signature S from the list of payload statistical signatures and compares the selected payload statistical signature S with the payload statistical information F.

If the numbers of payload packets match each other (F(n)=S(n)), the traffic analysis apparatus 3 determines whether the distance (D(F, S)) between the payload packet vector of the payload statistical information F and the payload packet vector of the corresponding payload statistical signature S is less than a distance threshold S(d) of the corresponding payload statistical signature S (operation 510). If the numbers of payload packets do not match each other (F(n)≠S(n)), the traffic analysis apparatus 3 selects another payload statistical signature S from the list of payload statistical signatures and compares the selected payload statistical signature S with the payload statistical information F.

If the distance (D(F, S)) between the payload packet vector of the payload statistical information F and the payload packet vector of the corresponding payload statistical signature S is less than the distance threshold S(d) (D(F, S)<S(d)), the traffic analysis apparatus 3 associates the two-way flow with an application program S(A) indicated by the corresponding payload statistical signature S (operation 512).

When determining in operation 510 whether the distance (D(F, S)) between the payload packet vector of the payload statistical information F and the payload packet vector of the corresponding payload statistical signature S is less than the distance threshold S(d), the city-block distance calculation method may be used. The city-block distance calculation method is defined by Equation 3:

$$d ( F , S ) = {\sum }_{i = 0}^{n - 1} \vert F ( {s}_{i} ) - S ( {s}_{i} ) \vert , \qquad ( 3 )$$

where F and S are n-dimensional vectors, and F(Sᵢ) and S(Sᵢ) are respective elements of the payload packet vectors F and S. The distance between the two vectors F and S can be calculated using a Euclidean distance calculation method. However, the present invention uses the simple city-block distance calculation method defined by Equation 3 in order to quickly process large traffic volumes. Distance calculation is performed only between vectors of the same dimension.

If the distance D(F, S) is less than the distance threshold S(d) of the corresponding payload statistical signature S, the two-way flow is associated with the application program S(A) indicated by the payload statistical signature S (operation 510). If the distance D(F, S) is greater than the distance threshold S(d) of the corresponding payload statistical signature S, the packet analysis apparatus 3 selects another payload statistical signature S from the list of payload statistical signatures and repeats the above operations.

When there is no more payload statistical signature to compare in the list of the payload statistical signatures (operation 516), then it is determined that an application for the two-way flow cannot be determined using a given payload statistical signature S (operation 518). The above operations are performed independently for all two-way flows. After the process of finding application programs for all two-way flows ends, the analysis process is completed.

According to an embodiment of the present invention, a flow generated from one or more payload packets captured through a network is associated with a corresponding application program by using transmission directions and payload sizes of the payload packets, instead of the is content of the payload packets. Therefore, the present invention does not invade the privacy of personal information and is applicable to high-speed networks.

In addition, classification of flows can be performed for n packets, which occur in chronological order, in a flow in order to associate the flow with a corresponding application program. Thus, flow classification can be performed from an initial stage of flow generation. Furthermore, since a city-block distance calculation method is used to classify flows according to application program, classification of the flows can be performed simply and quickly.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A traffic capture apparatus comprising:
a packet capture unit capturing one or more packets through a network;
a flow generation unit generating a two-way flow based on the captured packets; and
a payload statistical information generation unit generating payload statistical information based on payload packets in the generated two-way flow,
wherein each of the payload packets has a payload, and the payload statistical information contains information about transmission directions and payload sizes of the payload packets.

2. The traffic capture apparatus of claim 1, wherein the payload statistical information is a combination of a payload packet vector, which indicates the transmission directions and payload sizes of the payload packets, and the number of payload packets which form the payload packet vector.

3. The traffic capture apparatus of claim 2, wherein each transmission direction in the payload packet vector is represented by a plus sign (+) or a minus sign (−), wherein the plus sign (+) indicates that a transmission direction of a payload packet is from a client to a server, and the minus sign (−) indicates that the transmission direction of the payload packet is from the server to the client.

4. The traffic capture apparatus of claim 3, wherein a host which receives a synchronization (SYN) packet is designated as a server when a transmission control protocol (TCP) is used to exchange packets between hosts, and a host which receives a first packet is designated as a server when a user datagram protocol (UDP) is used to exchange packets between hosts.

5. The traffic capture apparatus of claim 2, wherein each payload size in the payload packet vector has a data size of a payload having application layer information.

6. The traffic capture apparatus of claim 1, wherein the payload statistical information generation unit generates the payload statistical information based on first n captured payload packets among a plurality of payload packets.

7. The traffic capture apparatus of claim 1, further comprising a flow record storage unit generating and storing a flow record which comprises the payload statistical information, a flow identifier, and basic flow information.

8. The traffic capture apparatus of claim 1, wherein each of the payload packets is a packet having a payload which contains the application layer information, and a control packet is not a payload packet.

9. A traffic analysis apparatus comprising:
a payload statistical signature storage unit storing a payload statistical signature which has different information about transmission directions and payload sizes of payload packets for each application program; and
a traffic classification unit associating a two-way flow received from a traffic capture apparatus, which captures traffic, with a corresponding application program by using the payload statistical signature.

10. The traffic analysis apparatus of claim 9, wherein the payload statistical signature is a combination of a transport layer protocol, a payload packet vector indicating transmission directions and payload sizes of payload packets, the number of payload packets which form the payload packet vector, a distance threshold, and an application program name.

11. The traffic analysis apparatus of claim 10, wherein each transmission direction in the payload packet vector is represented by a plus sign (+) or a minus sign (−), wherein the plus sign (+) indicates that a transmission direction of a payload packet is from a client to a server, and the minus sign (−) indicates that the transmission direction of the payload packet is from the server to the client.

12. The traffic analysis apparatus of claim 10, wherein each payload size in the payload packet vector has a data size of a payload having application layer information.

13. A traffic analysis system comprising:
a traffic capture apparatus capturing one or more packets through a network, generating a two-way flow based on the captured packets, and generating payload statistical information based on payload packets in the two-way flow; and
a traffic analysis apparatus receiving the two-way flow, which has the payload statistical information, from the traffic capture apparatus and associating the two-way flow with a corresponding application program by using a payload statistical signature which has different information about transmission directions and payload sizes of payload packets for each application program,
wherein each of the payload packets has a payload, and the payload statistical information contains information about transmission directions and payload sizes of the payload packets.

14. A traffic analysis method comprising:
establishing a list of payload statistical signatures, each having different information about transmission directions and payload sizes of payload packets for a corresponding application program;
comparing payload statistical information of a two-way flow captured through a network with a corresponding payload statistical signature in the list of payload statistical signatures; and
associating the two-way flow with a corresponding application program based on the comparison result,
wherein each of the payload packets has a payload, and the payload statistical information contains information about transmission directions and payload sizes of payload packets.

15. The traffic analysis method of claim 14, wherein the payload statistical information is a combination of a payload packet vector, which indicates transmission directions and payload sizes of the payload packets, and the number of payload packets which form the payload packet vector.

16. The traffic analysis method of claim 14, wherein the payload statistical signature is a combination of a transport layer protocol, a payload packet vector indicating transmission directions and payload sizes of payload packets, the number of payload packets which form the payload packet vector, a distance threshold, and an application program name.

17. The traffic analysis method of claim 14, wherein the comparing of the payload statistical information with the corresponding payload statistical signature comprises:
comparing a transport layer protocol of the payload statistical information with the transport layer protocol of the corresponding payload statistical signature;
comparing the number of payload packets which form the payload packet vector of the payload statistical information with the number of payload packets which form the payload packet vector of the corresponding payload statistical signature if the transport layer protocol of the payload statistical information matches the transport layer protocol of the corresponding payload statistical signature; and
determining whether a distance between the payload packet vector of the payload statistical information and the payload packet vector of the corresponding payload statistical signature is less than the distance threshold of the corresponding payload statistical signature if the number of payload packets which form the payload packet vector of the payload statistical information matches the number of payload packets which form the payload packet vector of the corresponding payload statistical signature.

18. The traffic analysis method of claim 17, wherein in the associating of the two-way flow with the corresponding application program, if the distance between the payload packet vector of the payload statistical information and the payload packet vector of the corresponding payload statistical signature is less than the distance threshold of the corresponding payload statistical signature, the two-way flow is associated with an application program indicated by the corresponding payload statistical signature.

19. The traffic analysis method of claim 17, wherein in the determining of whether the distance between the payload packet vector of the payload statistical information and the payload packet vector of the corresponding payload statistical signature is less than the distance threshold of the corresponding payload statistical signature, a city-block distance calculation method is used.

20. The traffic analysis method of claim 14, wherein in the comparing of the payload statistical information with the corresponding payload statistical signature, if the payload statistical information of the two-way flow does not match the corresponding payload statistical signature in the list of payload statistical signatures, another payload statistical signature is selected from the list of payload statistical signatures and compared with the payload statistical information.
